(19) United States
(12) Patent Application Publication
(10) Pub. No.: US 2023/0231382 A1
(43) Pub. Date: Jul. 20, 2023

(54) METERING AND TRACKING DISTRIBUTED ELECTRICAL ENERGY GENERATION

(71) Applicant: Calagen, Inc., Portsand, OR (US)

(72) Inventors: Gerard V. Lyons, Bend, OR (US); Gregory E. Grosh, Dallas, TX (US); Douglas F. Lyons, Bend, OR (US)

(73) Assignee: Calagen, Inc., Portland, OR (US)

(21) Appl. No.: 18/098,038

(22) Filed: Jan. 17, 2023

Related U.S. Application Data
(60) Provisional application No. 63/300,170, filed on Jan. 17, 2022.

(51) Int. Cl. H02J 3/14; H02J 3/38; H02J 3/00

(52) U.S. Cl. CPC H02J 3/144; H02J 3/381; H02J 3/004

(57) ABSTRACT

Disclosed is a centralized system and method for metering, tracking, and monetizing distributed digital energy assets. The system includes the creation and utilization of a secure digital energy-asset that acts as a key, authorizing specialized circuits to generate a specified amount of electrical energy. Digital information passed through the system includes data necessary to ascribe attribution (i.e., branding, trail of ownership, etc.) and permit monetization (i.e., kWhs, time, dollars, geography, etc.). Functionality and/or value that is ascribed to the digital energy asset can be enhanced by appending additional information and/or utility. The system also includes a means to normalize and evaluate a potentially infinite number of measurements commonly used in business models across multiple industries to a simplified listing of measurements required to track and monetize energy alone within the system.

### CROSS REFERENCE TO RELATED APPLICATION

This application claims priority from U.S. Provisional Application No. 63/300,170, filed Jan. 17, 2022, which application is incorporated herein by reference in its entirety.

### BACKGROUND

In the modern economy energy accounts for approximately 9% of global GDP, with approximately 80% of this amount derived from fossil-based fuels. Concurrently, there are social, economic, legislative, environmental, and other forces compelling a transition away from fossil-based fuels to non-fossil-based fuels. To accomplish this transition, it is generally believed that a restructuring of methods and systems of electrical energy transactions is required. A secular trend favoring electrical energy is anticipated to play a significant role in the replacement of fossil fuels. The current electrical energy paradigm is one of centralized generation, economics, transmission/distribution, in satisfaction of fully distributed demand/consumption. This current paradigm requires significant ongoing capital investment in centralized infrastructure.

### BRIEF DESCRIPTION OF THE DRAWINGS

FIG. 1 is a system diagram including an electrical energy generator that is responsive to an Authorization-to-Generate right (ATG-R).

FIG. 2 is a system diagram according to another embodiment of an electrical energy generator that is responsive to an ATG-R.

FIG. 3 is a system diagram of a system for metering and tracking of digital energy assets that enable distributed energy generation.

FIG. 4 is a flowchart according to one embodiment for metering and tracking of digital energy assets that enable distributed energy generation.

FIG. 5 is a computing environment that can be used in association with the embodiments described herein.

### DETAILED DESCRIPTION

As a growing array of distributed energy generation technologies become available such as U.S. Pat. No. 11,309,810 or become increasingly available, such as U.S. Pat. No. 9,156,720 there is a new need for systems that permit the value of distributed energy generation to be captured and transacted at the speed and efficiency of digital computation and communication. New revenue sources, opportunities for new risk management strategies, and non-disruptive strategies for implementing an energy transition are all highly desired. A need for decentralized generation and the solutions it could provide is growing.

A method of using centralized systems to monetize decentralized electrical energy generation is disclosed herein. In the system disclosed centralized economics are retained, while enabling the positioning of distributed generation at or near the point of consumption. With the benefit of cloud-based networked technologies, it is possible for the disclosed Systems described to retain the benefits of centralized economics while concurrently enabling an energy transition that is, economically favored, more convenient, environmentally preferred, and less disruptive.

The described system allows the application of centralized economics to any mechanism of decentralized energy generation. The centralized system can include an ability to create a set of code that authorizes the generation of electrical energy on a distributed basis. Additionally, the system can include a means of measuring and tracking electrical energy and rights to generate electrical energy. Still further, the system can include a means for businesses to retain the familiarity of their existing business models while monetizing the economic value of energy generated within or adjacent to their products, i.e., it permits product companies to create a revenue stream relating to the required energy their product demands. Finally, the system can include a centralized system and method for metering, tracking, and monetizing distributed digital energy-assets.

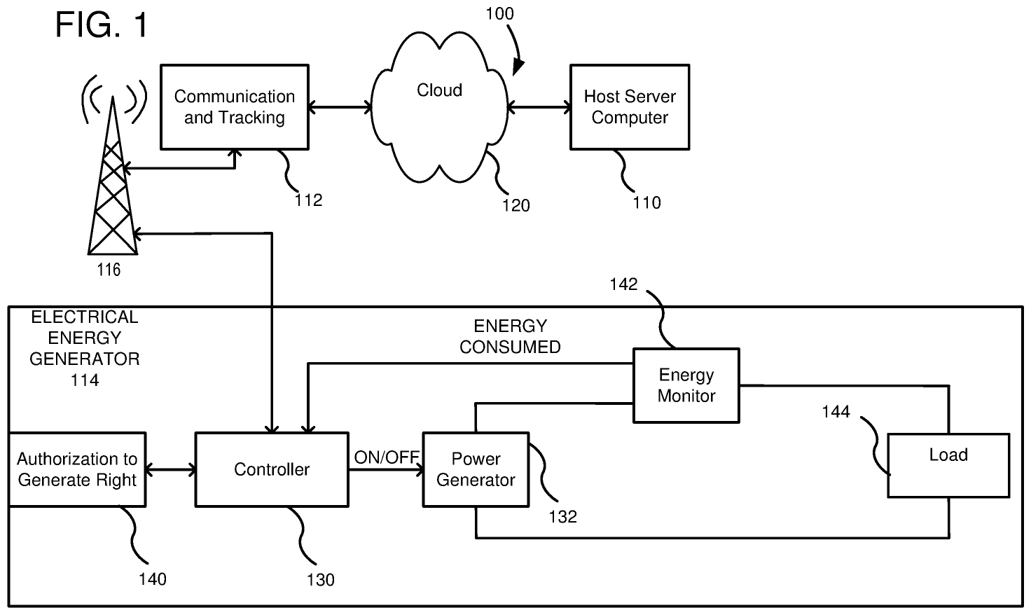

FIG. 1 shows a system 100 according to a first embodiment. The system includes a host server computer 110, a communication and tracking server 112 and an electrical energy generator 114. The host server computer 110 can be used to create and distribute authorizations to generate (ATGs) and communicates with the server 112 through a cloud environment 120. The server 112 for communication and tracking can be used as an intermediate server that communicates with the electrical energy generator 114 through a network, such as a cellular network 116 (other networks can be used) for tracking electrical energy generation and consumption. Additionally, the server 112 can divide the ATG into multiple ATG rights (ATG-R). A proposed object of value that flows through this system 100 is a secure digital energy-asset that authorizes specialized circuits to generate a specified amount of electrical energy (i.e., the ATG). The energy content of an ATG can be divisible. For example, a large ATG can be subdivided into two or more smaller ATGs. Functionality and information content of an ATG is accreted as it is transacted through a Marketplace and beyond. Furthermore, the ATG is a depleting asset with depletion determined as proportional to energy generated relative to total energy authorized to be generated.

The electrical energy generator 114 includes a controller 130 coupled to a power generator 132. The power generator 132 can be any type of generator including gasoline, hydrogen, solar, wind, hydroelectric, etc. The controller 130 is responsive to a stored ATG-R 140 to switch the power generator ON or OFF. When switched ON, an energy monitor 142 can detect an amount of energy generated and consumed by a load 144. The energy monitor 142 can report back the amount of energy consumed or generated to the controller 130, which can then report the same to the server computer 112.

Because the ATG created by and passing through the system 100 is a digital construct, functionality and/or value can be enhanced by appending additional information and/or utility. For example, it would be preferable to additionally, append to this digital asset a minimum set of data necessary to ascribe attribution (i.e., branding, trail of ownership, etc.) and permit a minimum set of mechanisms for calculating monetization values (i.e., kWhs, time, dollars, geography, etc.) The primary initial value of an ATG created by and contained within our system is directly proportional to the residual value of energy it is enabled to authorize. Users of the system, however, may express their own value proposition to their customers in units that are not necessarily denominated in energy. Therefore, the system can provide a means to transact business utilizing a potentially infinite number of differing valuation mechanisms (as utilized by users of the system in the conduct of their business models) while retaining the relative simplicity of the primary valuation mechanism (measured energy).

The system can accomplish this by additionally providing a dual track for the measurement (including increment, decrement) of valuation mechanisms within the system—one track for the primary valuation concern, Energy; and a second track for Rights that can then be amortized based upon units or any methodology the user of the system elects as relevant to meeting the requirements of its customers and its business objectives (i.e., dollars, time, subscriptions, miles, warranty period, kWhs, combinations of units/measures, or any other relevant units or combinations of units).

A “Unitless Ratio” can be derived from the unitless value of the first (primary) track and the unitless second track (a user defined track). This Unitless Ratio provides a mathematical means for an integrated system to normalize potentially infinite complexity of measurement units at an End User level (outside the System) with the binary simplicity of measurement requirements within the system denominated exclusively in units of energy. A Unitless Ratio is a tool that can be utilized by a user of the system to evaluate the efficiency of their chosen business model. For example: If in the aggregate the (unitless) ratio of the proportion of amortization of a right to the proportion of depletion of energy is greater than one, then the business model crafted by the user of the system could in effect view the consumption of Rights to its ATGs (valued at a pass-thru rate) as a profit center opportunity. If the ratio is less than one, then the consumption of Rights to ATGs would in effect constitute a cost center. Users of the system can utilize this Unitless Ratio in analyzing the relative efficiency of either profit centers or the relative magnitude of their cost centers. Additionally, (outside the constraints of the contemplated System) users of the System will likely mark up the value of kWhs prior to passthrough of Rights to an End User account. Any mark-up would provide or enhance an incremental profit center opportunity for a user of the System.

In order to take advantages of the teachings taught in this disclosure, the following procedure can be utilized. Assumption: a car manufacturer (Licensee) who has designed and incorporated an electrical energy generation technology directly into the vehicle has reached agreement to acquire ATGs with the provider or authorized representative of the System:
Contact the issuer or authorized representative of the ATG and arrange to acquire an ATG.
Upon agreement, issuer (or authorized representative) of an ATG provides secure authorization to access the System.
Licensee accesses Systems and acquires ATGs that contains the quantity of acquired energy.
Licensee accesses the Systems and downloads the code associated with the ATG.
Licensee appends the downloaded ATG code with the measurement mechanisms to be utilized for its business model. For example, an automobile company may adopt a business model that amortizes the value of the ATG over the period of the car warranty, the number of miles driven, monthly subscription, or combinations thereof.
Licensee installs the code associated with the Right to access the value of the ATG into the energy generation device.
The device (i.e. the automobile) now has a Right to generate its own electricity.
The amount of electricity generated (at the device level i.e. the automobile) is periodically reported back to the licensee who decrements that value from the remaining value of the ATG.
The licensee reports back to the licensor or his representative the total energy generated across the entire suite of licensee's products that have a Right to consume the ATG. For example an automobile company likely will have multiple brands: trucks, cars, motorcycles, etc.
Licensee analyzes efficiency of its business model (the amortization rate at which Rights that it has sold to its customer are being consumed will represent revenues and the depletion of ATGs utilized to generate energy will represent costs—they use the unitless ratio to assess the performance of their business model).
As necessary licensee acquires additional ATGs to replenish a balance that was depleted by generation.

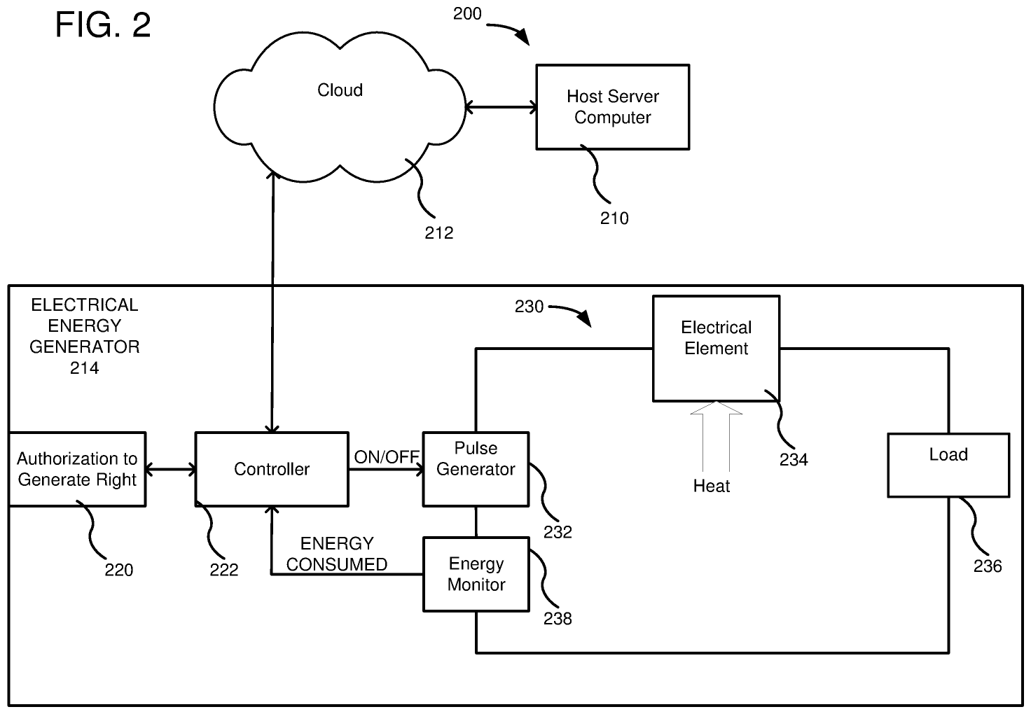

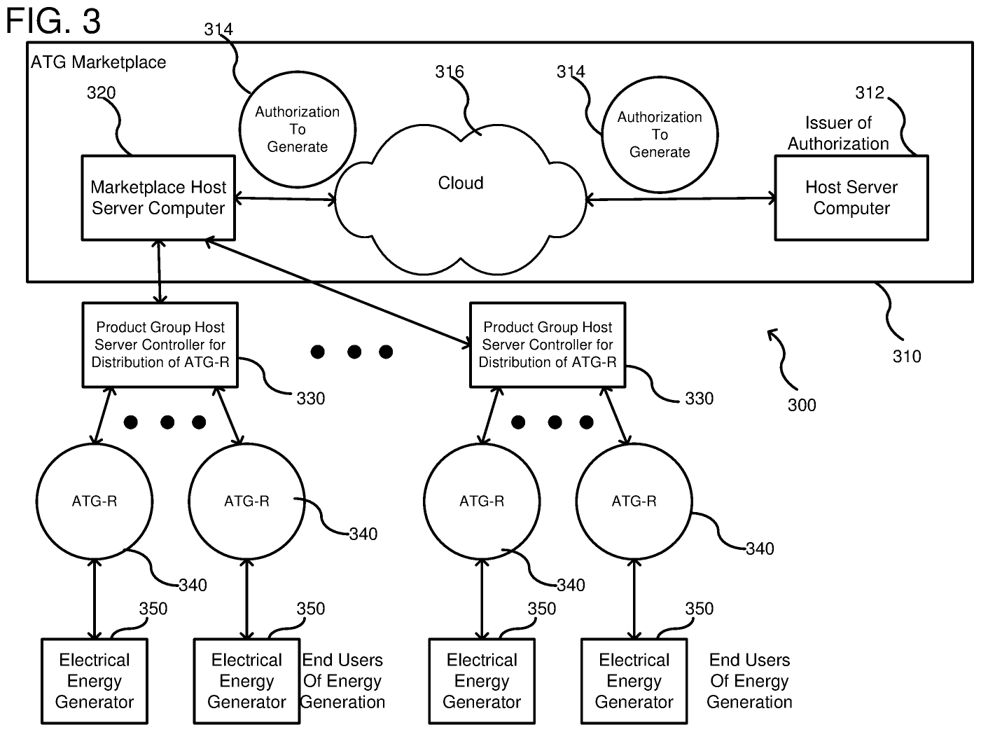

FIG. 2 shows a system 200 according to another embodiment. In this embodiment, a host server computer 210 communicates through a cloud network 212 directly with the electrical energy generator 214. Alternatively, one or more intermediate server computers (such as shown in FIG. 3) can be inserted between the host server computer 210 and the electrical energy generator 214. The electrical energy generator 214 includes storage 220 for storing an ATG-R and a controller 222 coupled to the storage. The controller 222 can switch ON/OFF a power generation circuit 230. The power generation circuit 230 comprises a pulse generator 232, an electrical element 234, and a load 236. The pulse generator 232 can be a device that generates an electrical pulse. In some embodiments, the pulse generator 232 can generate a continuous stream of electrical pulses at periodic intervals. Ideally, the pulse generator 232 generates an electrical pulse in which the voltage output by the pulse generator increases rapidly over a short period of time. This could be done with a square wave with a short rise time, or a sine wave, a saw-tooth wave, or similar output voltage wave with a high frequency. The circuit can generate thermoelectric power with an electrical pulse output by the pulse generator 232 having a dV/dt as small as 100 V/s. Results indicate that a good efficiency can be obtained with sinusoidal signals having a frequency as low as 4.7 kHz and in certain cases as low as 900 Hz. However, ideally the pulse generator 102 outputs a pulse having a dV/dt of at least 100 V/μs or preferably 10,000 to 100,000 V/μs or higher.

When the pulse generator 232 outputs an electrical pulse having a high dV/dt, the electrical element 234 converts thermal energy to electrical energy, as described herein. The electrical element 234 should have a conductive path with sufficient surface area to absorb heat, thereby allowing the electrical element to act as a heat sink. This can be achieved by the electrical element 234 having a heavier gauge, a greater length, or a non-cylindrical shape with greater surface area. In some examples, the electrical element 234 can be a copper wire having a gauge (e.g., 10 AWG) that is heavier than the wires or electrical conductor connecting the electrical element to the pulse generator 232 and the load 236. In other examples, the electrical element 104 can comprise any other conductive material. In one example, the electrical element 234 is a heavier gauge wire with respect to other signal conductors in the circuit and has a length of at least three feet. The electrical element 234 can be a simple wire, a coil, or any conductive element that can absorb heat. When the electrical pulse output by the pulse generator 232 with a high dV/dt ratio is applied to one side of the electrical element 234, the electrical element gets colder and a voltage appears on the other side the electrical element with a higher power level than what was produced by the pulse generator 232. As such, the sharp pulse output by the pulse generator 232 causes the electrical element 234 to convert thermal energy into electrical energy. The higher the dV/dt ratio of the pulse output by the pulse generator 232, the greater the amount of thermal energy that is converted to electrical energy.

The electrical element 234 is connected to a load 236. The load can be any device that consumes or stores electrical power (e.g., an electrical appliance). In operation, the pulse generator 232 can output an electrical pulse having a first electrical power. This causes the electrical element 234 to convert thermal energy into additional electrical energy. Accordingly, the pulse is applied to the load 236 with a second electrical power greater than the first electrical power. An energy monitor 238 can track power used and report the consumed energy to the controller 222. Using the energy consumed, the energy generated can be determined by the controller 222 and reported back to the host server computer 210. Additionally, the controller can compare the energy consumed to the ATG-R 220 and determine whether to switch off the power generator 230, such as by switching off the pulse generator 232.

FIG. 3 shows another embodiment of a system 300 used for metering and tracking electric energy distribution. An ATG marketplace 310 includes a host server computer 312 that is the issuer of the ATG 314. The ATG can be issued to a marketplace host server computer 320 via a network, such as is shown generically at 316. The marketplace host server computer 320 can sell the ATG 314 to different product group server computers 330, which can divide the ATG into any number of ATG-Rs, shown at 340. The ATG-Rs can then be distributed to the electrical energy generators 350, which can then be stored in a memory, such at shown at 140 in FIG. 1 or 220 in FIG. 2. The electrical energy generators 350 can be any of the types shown in FIGS. 1 and 2. The ATG-R 340 can be used by electrical energy generators 350 to turn on energy generation and/or energy consumption.

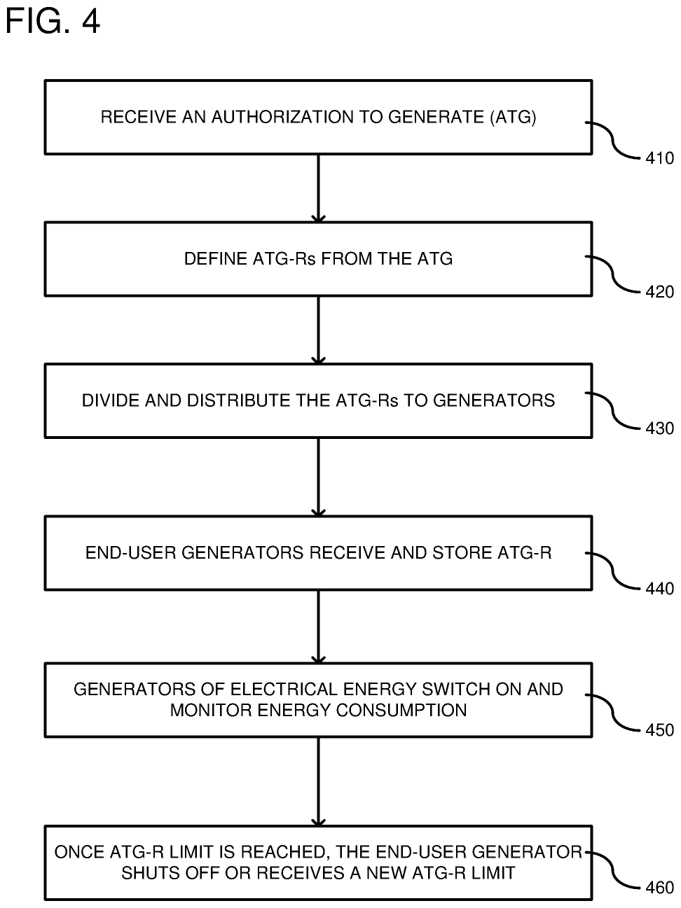

FIG. 4 is a flowchart according to one embodiment. At process block 410, an authorization to generate is received. For example, in FIG. 3, one of the product group server computers 330 can receive the ATG 314. In process block 420, multiple ATG-Rs can be defined from the ATG. For example, the ATG can be divided into parts wherein the addition of the parts define the whole. At process block 430, multiple of the ATG-Rs can be divided and distributed. For example, in FIG. 3, multiple ATG-Rs 340 can be generated and distributed to the end users 350. In process block 440, the end-user generators receive and store the ATG-Rs. For example, in FIG. 1, the ATG-R can be stored at 140. At process block 450, the generators of electrical energy switch ON and monitor energy consumption. For example, in FIG. 1, the controller 130 can switch ON the power generator 132 and the energy monitor 142 can measure the energy generation and report the same to the controller 130. The controller 130 can perform a comparison using the stored ATG-R and shut OFF the power generation once the ATG-R amortizes to zero.

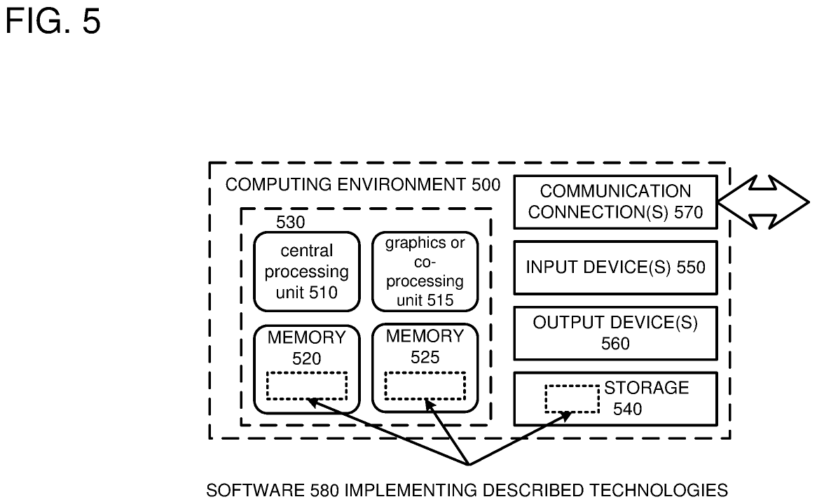

FIG. 5 depicts a generalized example of a suitable computing environment 500 in which the described innovations may be implemented. The computing environment 500 is not intended to suggest any limitation as to scope of use or functionality, as the innovations may be implemented in diverse general-purpose or special-purpose computing systems. For example, the computing environment 500 can be any of a variety of computing devices (e.g., desktop computer, laptop computer, server computer, tablet computer, microprocessor, etc.)

With reference to FIG. 5, the computing environment 500 includes one or more processing units 510, 515 and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), non-volatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s). For example, the computing environment of FIG. 5 can be any of the server computers shown in FIG. 3.

A computing system may have additional features. For example, the computing environment 500 includes storage 540, one or more input devices 550, one or more output devices 560, and one or more communication connections 570. An interconnection mechanism (not shown) such as a bus, controller, or network interconnects the components of the computing environment 500. Typically, operating system software (not shown) provides an operating environment for other software executing in the computing environment 500, and coordinates activities of the components of the computing environment 500.

The tangible storage 540 may be removable or non-removable, and includes magnetic disks, magnetic tapes or cassettes, CD-ROMs, DVDs, SSDs, or any other medium which can be used to store information in a non-transitory way and which can be accessed within the computing environment 500. The storage 540 stores instructions for the software 580 implementing one or more innovations described herein.

The input device(s) 550 may be a touch input device such as a keyboard, mouse, pen, or trackball, a voice input device, a scanning device, or another device that provides input to the computing environment 500. The output device(s) 560 may be a display, printer, speaker, CD-writer, or another device that provides output from the computing environment 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

We claim:

1. A method of metering and tracking distributed energy generation, comprising:
receiving a digital energy asset that authorizes an amount of electrical energy to be generated;
based upon the received digital energy asset, distributing multiple measurable amounts of electrical energy generation rights to a plurality of end users of energy generation;
receiving from the end users of energy generation, an amount of energy generated by the end users;
calculating or receiving from the end users of energy generation, an amount of energy generation rights consumed; and
comparing the amount of energy generation rights consumed to the measurable amounts of electrical energy generation rights provided to each end user and controlling the energy authorized to be generated by each end users based upon the comparison.

2. The method of claim 1, wherein the comparing includes generating a ratio between the portion of electrical energy generation rights consumed and the portion of energy generated by end users.

3. The method of claim 1, further including generating electrical energy by the end users based upon the distributed electrical energy generation rights.

4. The method of claim 3, wherein the generating of electrical energy includes switching ON an electrical generator via a control circuit that controls a status (ON/OFF) of an electrical energy generator.

5. The method of claim 1, wherein the electrical energy generator monitors and reports the amount of energy generated.

6. The method of claim 1, further comprising receiving a digital energy asset that authorizes generation of electrical energy and dividing the authorization into multiple of the digital authorization rights including the digital authorization right received at the end-user generator.

7. The method of claim 6, wherein the digital energy asset is received from an authorization-to-generate marketplace.

8. The method of claim 1, wherein the digital authorization to generate is a depleting asset with the depletion determined as proportional to energy generated at the user level relative to a total energy authorized to be generated at the group level.

9. A method, comprising:
receiving at an end-user generator, a digital authorization right to generate electrical energy;
storing the digital authorization right at the end-user generator;
in response to the stored digital authorization right, enabling a generator of electrical energy to switch on;
using a monitor at the end-user generator, monitoring an amount of electrical energy generated; and
using a monitor at the end-user generator, monitoring an amount of electrical energy generation right consumed.

10. The method of claim 9, wherein the digital authorization right that permits the generation of energy is divided from an authorization to generate energy received from a marketplace server.

11. The method of claim 9, further including comparing the amount of electrical energy right consumed to an amount of the digital authorization right and switching OFF the generator (or not permitting the generator to be turned ON) if the digital authorization right has been consumed or exceeded.

12. The method of claim 11, wherein the comparing includes generating a ratio between the portion of digital authorization right consumed and the portion of energy generated by the end-user generator(s).

13. The method of claim 9, wherein the electrical energy generation rights include an enabling digital code and a measurement mechanism for measuring and reporting the amount of electrical energy generated.

14. The method of claim 9, wherein the switching ON of the generator includes switching ON an electrical generator via a control circuit that controls the status (ON/OFF) of an electrical energy generator.

15. A system, comprising:
a host server computer for issuing authorizations to generate (ATG);
a marketplace host server computer for distributing the ATGs to third-party server computers, wherein the third-party server computers are configured to distribute authorization-to-generate rights (ATG-R) to end users of energy generation; and
an electrical energy generator coupled to the third-party server computers, the electrical energy generator configured to respond to receiving an ATG-R and to start generating electrical energy.

16. The system of claim 15, wherein the ATG is divisible into multiple ATG-Rs.

17. The system of claim 15, wherein the ATG includes a digital code and a measurement mechanism for measuring an amount of electrical energy.

18. The system of claim 15, wherein the electrical energy generator includes a control circuit that is configured to be switched ON and OFF in response to the ATG-R.

19. The system of claim 15, wherein the electrical energy generator includes a monitor for monitoring generation of electrical energy.

20. The system of claim 15, wherein the third-party server computers are configured to generate a ratio between a portion of the ATG-R consumed and a portion of energy generated by electrical energy generator(s).
